(19) United States
(12) Patent Application Publication
(10) Pub. No.: US 2024/0296148 A1
(43) Pub. Date: Sep. 5, 2024

(54) Digital Content Migration

(71) Applicant: International Business Machines Corporation, Armonk, NY (US)

(72) Inventors: Kelley Anders, East New Market, MD (US); Francisco Chavez Clemente, Tlajomulco (MX)

(21) Appl. No.: 18/177,355

(22) Filed: Mar. 2, 2023

(51) Int. Cl. G06F 16/21; G06F 16/28

(52) U.S. Cl. CPC G06F 16/214; G06F 16/285

(57) ABSTRACT

Migrating digital content is provided. A content migration confidence score is generated, using a content migration machine learning model, for migrating digital content accessed by a user in a source data repository to a target data repository of a plurality of data repositories that contains a related topic to a topic corresponding to the digital content accessed by the user based on an analysis of information regarding user engagement activity with the digital content accessed by the user. Migration of the digital content accessed by the user in the source data repository to the target data repository containing the related topic to the topic corresponding to the digital content accessed by the user is executed, using the content migration machine learning model, in response to determining that the content migration confidence score is greater than a user-defined minimum content migration confidence score threshold level.

### BACKGROUND

The disclosure relates generally to digital content and more specifically to migrating digital content between repositories along a content fluidity spectrum using a content migration machine learning model.

Digital content is any content, material, information, or the like that exists in the form of digital data. Forms of digital content include, for example, text, audio files, video files, graphics, animations, images, and the like, which can be digitally broadcast, streamed, or contained in computer files. Primarily, digital content is distributed via computers and the Internet. Generally, if a person is online, then that person is viewing or listening to digital content.

### SUMMARY

According to one illustrative embodiment, a computer-implemented method for migrating digital content is provided. A computer, using a content migration machine learning model, generates a content migration confidence score for migrating digital content accessed by a user in a source data repository to a target data repository of a plurality of data repositories that contains a related topic to a topic corresponding to the digital content accessed by the user based on an analysis of information regarding user engagement activity with the digital content accessed by the user. The computer, using the content migration machine learning model, executes migration of the digital content accessed by the user in the source data repository to the target data repository containing the related topic to the topic corresponding to the digital content accessed by the user in response to the computer determining that the content migration confidence score is greater than a user-defined minimum content migration confidence score threshold level. According to other illustrative embodiments, a computer system and computer program product for migrating digital content are provided.

### BRIEF DESCRIPTION OF THE DRAWINGS

FIG. 1 is a pictorial representation of a computing environment in which illustrative embodiments may be implemented;

FIG. 2 is a diagram illustrating an example of a content migration machine learning model in accordance with an illustrative embodiment; and

FIGS. 3A-3B are a flowchart illustrating a process for migrating digital content in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

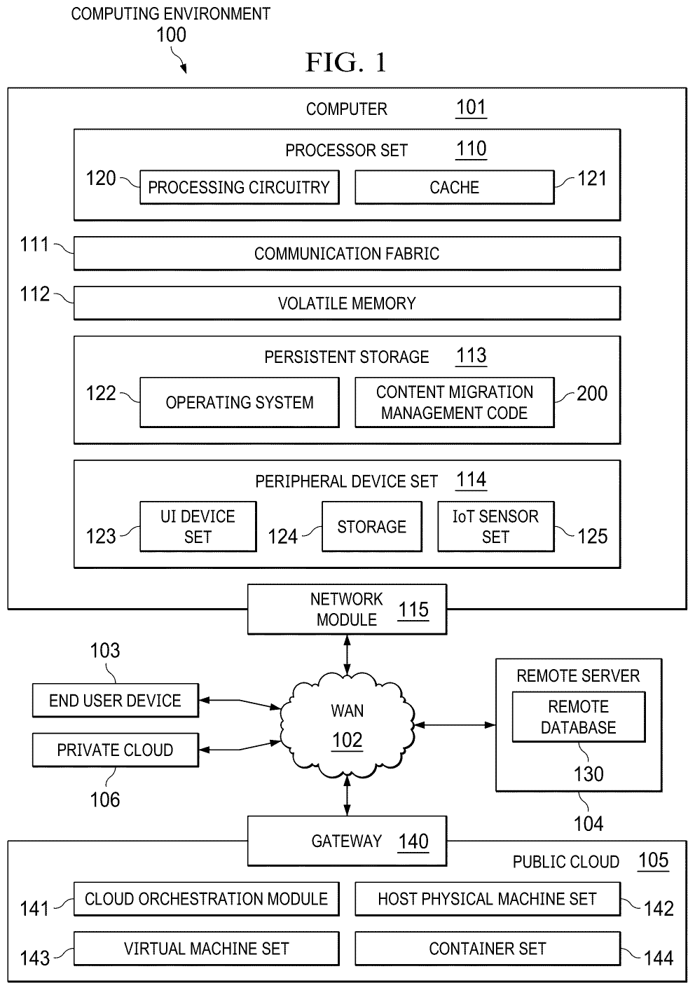

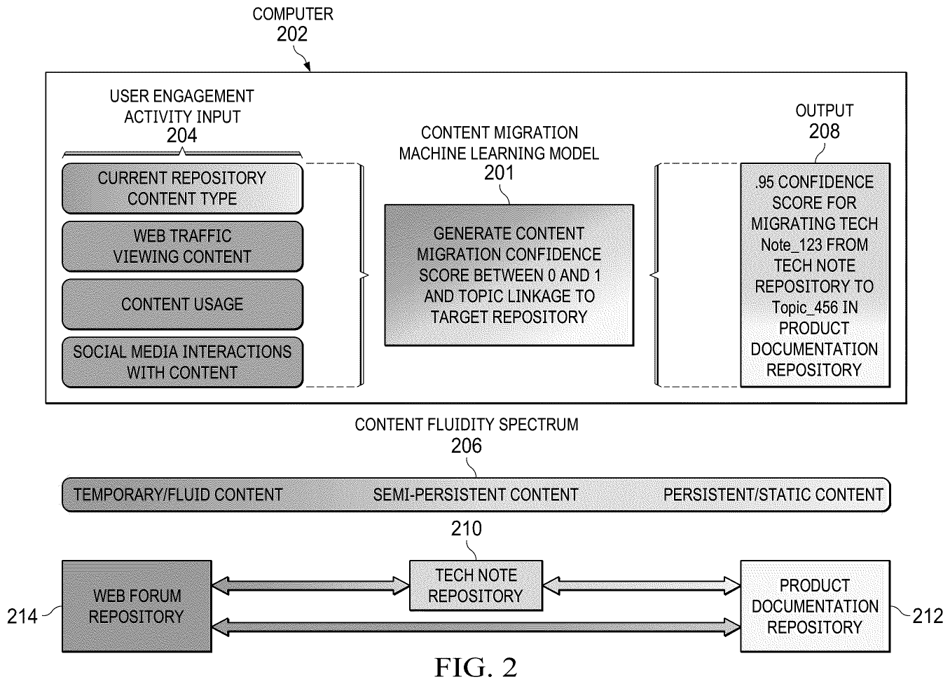

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as content migration management code 200. For example, content migration management code 200 takes into account the topic of digital content and the fluid nature of that topic. Content migration management code 200 identifies which digital content should be migrated from one data repository to another utilizing a content migration machine learning model, which links topics of digital content across a plurality of data repositories and generates weighted content migration confidence scores to determine when and where to migrate content corresponding to a particular topic of digital content. As used herein, a data repository can be any type of storage, container, database, website, or the like that can store digital content.

Content migration management code 200 generates and trains the content migration machine learning model using historic content migration patterns between data repositories containing different topics of digital content. Content migration management code 200 utilizes the content migration machine learning model to determine the degree of fluidity of digital content and then migrates the digital content to an appropriate target data repository, which exhibits the characteristics as defined by the content migration machine learning model and is aligned with the user's intent. In other words, content migration management code 200 takes into account the frequency of use and characteristics of the digital content to determine where on the content fluidity spectrum the digital content falls and which type of data repository the digital content best aligns with. For example, content migration management code 200 can migrate digital content from a more fluid repository where digital content is dynamic or constantly updating and changing, such as a web forum or chat room, to a more permanent or static repository, such as product documentation database. In other words, content migration management code 200 migrates digital content from one repository to another based on the fluid nature or static nature of the topic corresponding to that particular digital content. Furthermore, content migration management code 200 generates a unique identifier for respective digital content in order for content migration management code 200 to trace the migration path of that particular digital content from a source data repository to a target data repository.

In addition to content migration management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and content migration management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in content migration management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The content migration management code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers. EUD 103 is any computer system that is used and controlled by an end user (for example, a user of the content migration management services provided by computer 101), and may take any of the forms discussed above in connection with computer 101. EUD 103 typically receives helpful and useful data from the operations of computer 101. For example, in a hypothetical case where computer 101 is designed to provide a content migration recommendation to the end user, this content migration recommendation would typically be communicated from network module 115 of computer 101 through WAN 102 to EUD 103. In this way, EUD 103 can display, or otherwise present, the content migration recommendation to the end user. In some embodiments, EUD 103 may be a client device, such as thin client, heavy client, mainframe computer, desktop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a content migration recommendation based on content migration historical data, then this content migration historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of”' may be, for example, without limitation, two of item A; one of item B; and ten of item C; four of item B and seven of item C; or other suitable combinations.

Digital content can reside in one or more data repositories, ranging from dynamic or constantly updating and changing repositories, such as, for example, a web forums or chat rooms, to a more permanent or static data repositories, such as, for example, a product documentation database. Digital content can be categorized in many ways. For example, current solutions can categorize digital content depending on the storage location of the digital content and how often the digital content is updated. However, current solutions are not capable of determining when certain digital content is ready to be migrated to a different data repository or determining which data repository to migrate the digital content to.

Illustrative embodiments are capable of identifying particular digital content that can be migrated (e.g., promoted) from a temporary data repository, such as, for example, a web forum or chat room where updates to the digital content are occurring at a high frequency, to a more persistent data repository, such as, for example, a product documentation database where the digital content is more stable or static. In addition, illustrative embodiments are capable of identifying particular digital content that can be migrated (e.g., demoted) from a persistent data repository to a more temporary data repository when new updates or new conversations need to occur regarding that particular digital content. In other words, illustrative embodiments are capable of bi-directional or multi-directional migration of digital content between data repositories.

Therefore, illustrative embodiments know when and where digital content is migrated from one repository to another, and when changes occur to any digital content across repositories that necessitate a review and potential modification of digital content location by illustrative embodiments. For example, illustrative embodiments are capable of determining when a product document needs to be migrated from a persistent product document repository to a temporary web forum repository for discussion by a group of users (e.g., when a management console corresponding to the product document needs to be redesigned).

As a result, by illustrative embodiments automatically identifying relevant digital content and migrating that digital content to an appropriate data repository, illustrative embodiments decrease or minimize the need of users to create support tickets to find certain digital content corresponding to a particular topic. Thus, illustrative embodiments save time and system resources and increase user satisfaction.

Illustrative embodiments identify where related topics of digital content reside across a plurality of different data repositories, by digital content type or format (e.g., text, document, audio, video, or the like). Illustrative embodiments identify each respective data repository of the plurality of different data repositories and the type of digital content stored in a particular data repository, ranging from fluid to static digital content, for a given topic. Illustrative embodiments can accomplish this using application programming interface calls and wrapping results in javascript object notation, or using existing topic analysis methods.

In addition, illustrative embodiments collect reference data (e.g., information regarding where given topics of digital content reside in different data repositories) and transaction data (e.g., how users interact with different digital content). Illustrative embodiments analyze the collected reference data and transaction data to determine user engagement activity with digital content in each respective data repository. User engagement activity can include, for example: 1) number of times digital content regarding a particular topic has been viewed by users and for how long (e.g., time on webpage), which illustrative embodiments can collect from, for example, web traffic analytics applications; 2) number of times the digital content was utilized by users to resolve an issue, along with issue severity, topic, resolution status, attached content, time to resolution duration, and the like; and 3) number of web forum and social media platform interactions, such as, for example, shares, retweets, likes/dislikes, upvotes/downvotes, and comments, along with their inter-arrival rates, corresponding to the digital content.

Afterward, illustrative embodiments utilize the content migration machine learning model to analyze the user engagement activity information obtained above (e.g., current data repository location of respective digital content by topic and type, web traffic views of respective digital content by topic and type, utilization of respective digital content to resolve issues by topic and type, social media interactions with respective digital content by topic and type, and the like). The content migration machine learning model generates a normalized, weighted content migration confidence score between the values of zero (0) and one (1) for determining whether to migrate particular digital content from a source data repository to an appropriate target data repository based on the analysis of the user engagement activity information. A content migration confidence score of 0 equals least confidence and a content migration confidence score of 1 equals highest confidence.

Illustrative embodiments can utilize one or more methods for generating content migration confidence scores depending on user preference or business needs. For example, illustrative embodiments can utilize a hidden Markov model because illustrative embodiments already know the outcome (i.e., that a piece of digital content will be migrated across the content fluidity spectrum from one data repository to another), but illustrative embodiments do not know the probability of migrating the digital content to a particular data repository. Illustrative embodiments can configure the probability for a certain threshold level based on the inputs to the content migration machine learning model and can be personalized to the user. Illustrative embodiments can also utilize Jaccard distance or cosine similarity based on the overlap or similarity of keywords corresponding to the topic of the digital content in different data repositories. Further, illustrative embodiments can utilize logistical regression or multiple linear regression to determine the relationship between, for example, web traffic views, content utilization, and social media interactions corresponding to the digital content. As an illustrative example, in a technical support setting, the greater the number of higher severity issues that a particular piece of digital content is used to resolve those higher severity issues, the higher the confidence score will be to migrate that particular piece of digital content to a more persistent type of data repository.

Illustrative embodiments compare the generated content migration confidence score with a user-defined minimum content migration confidence score threshold level (e.g., 0.6, 0.7, 0.75, 0.8, 0.85, 0.9, 0.95, or the like). If illustrative embodiments determine that the generated content migration confidence score is greater than the user-defined minimum content migration confidence score threshold level, then illustrative embodiments link the topic corresponding to the digital content to a related topic in a target data repository for migration of the digital content. If illustrative embodiments determine that the generated content migration confidence score is less than the user-defined minimum content migration confidence score threshold level, then illustrative embodiments do not migrate the digital content from the source data repository.

Furthermore, illustrative embodiments generate a unique identifier for respective digital content, which provides a mapping to match topics of digital content across different data repositories, based on, for example, attributes within the content migration machine learning model, itself. This unique identifier for digital content can be, for example, a hash, a link, generated randomized code, or the like. Illustrative embodiments store this unique identifier, which preserves the linkages of the topics of the digital content between the data repositories, for reference.

Illustrative embodiments utilize the content migration machine learning model to migrate the digital content to a related topic in an appropriate target data repository. In response to illustrative embodiments identifying particular digital content for migration to a different data repository utilizing the content migration machine learning model, illustrative embodiments can either move that particular digital content to a persistent product documentation repository and keep the original digital content (e.g., an online article) as a placeholder with a link to the original digital content, or move that particular digital content altogether to the persistent product documentation repository and let that particular digital content surface via search engines.

Moreover, illustrative embodiments record the content migration transaction results for future reference. For example, if digital content corresponding to a particular topic “X” typically starts out in a temporary web forum repository and then the content migration machine learning model of illustrative embodiments later migrates the digital content corresponding to that particular topic “X” to a persistent product documentation repository without the digital content becoming a tech note in a semi-persistent tech note repository along the content fluidity spectrum, then the content migration machine learning model utilizes that content migration trajectory information for that particular topic “X” in the future. It should be noted that illustrative embodiments rank the plurality of data repositories according to the content fluidity spectrum from a temporary or fluid content repository, to a semi-persistent content repository, to a persistent or stable content repository. Furthermore, illustrative embodiments can utilize that content migration trajectory information for that particular topic “X” as training data to increase the predictive accuracy of the content migration machine learning model.

Thus, illustrative embodiments provide one or more technical solutions that overcome a technical problem with determining when and where to migrate digital content from one data repository to another. As a result, these one or more technical solutions provide a technical effect and practical application in the field of digital content storage.

With reference now to FIG. 2, a diagram illustrating an example of a content migration machine learning model is depicted in accordance with an illustrative embodiment. Content migration machine learning model 201 can be implemented in content migration management code, such as, for example, content migration management code 200 in FIG. 1. Content migration machine learning model 201 runs in computer 202. Computer 202 can be, for example, computer 101 in FIG. 1.

Content migration machine learning model 201 receives input 204, which is information regarding user engagement activity with particular digital content accessed by a client device user via a network. In this example, input 204, which comprises the user engagement activity with that particular digital content, includes: identification of the current or source data repository containing that particular digital content accessed by the client device user; type of that particular digital content along content fluidity spectrum 206 such as temporary/fluid digital content (e.g., forum or chat posts), semi-persistent digital content (e.g., technical notes), or persistent/static digital content (e.g., product documentation); topic of that particular digital content; number of web traffic views of that particular digital content; usage of that particular digital content to resolve issues; and number of social media interactions with that particular digital content.

Content migration machine learning model 201 analyzes all of the user engagement activity information contained in input 204. Based on the analysis of input 204, content migration machine learning model 201 generates a content migration confidence score between 0 and 1 and a digital content topic linkage to a target data repository. Output 208 represents the result of the analysis. In this example, output 208 is a generated content migration confidence score of 0.95 for migrating tech note_123 from tech note repository 210 to topic_456 in product documentation repository 212 along content fluidity spectrum 206. In other words, tech note repository 210 contains semi-persistent digital content and product documentation repository 212 contains persistent/static digital content. It should be noted that content fluidity spectrum 206 also includes web forum repository 214, which contains temporary/fluid digital content.

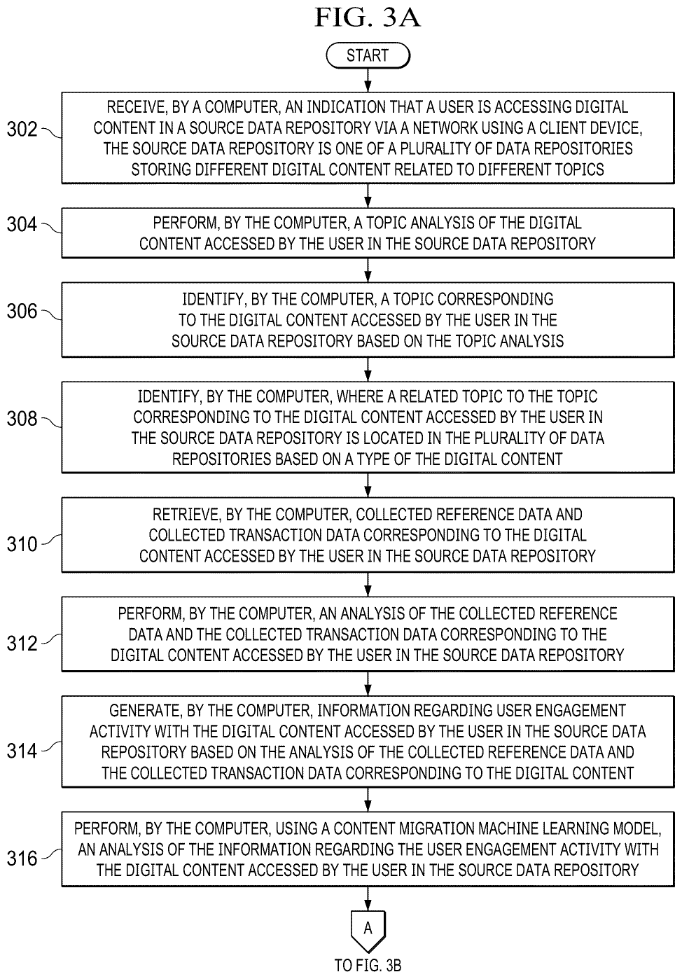

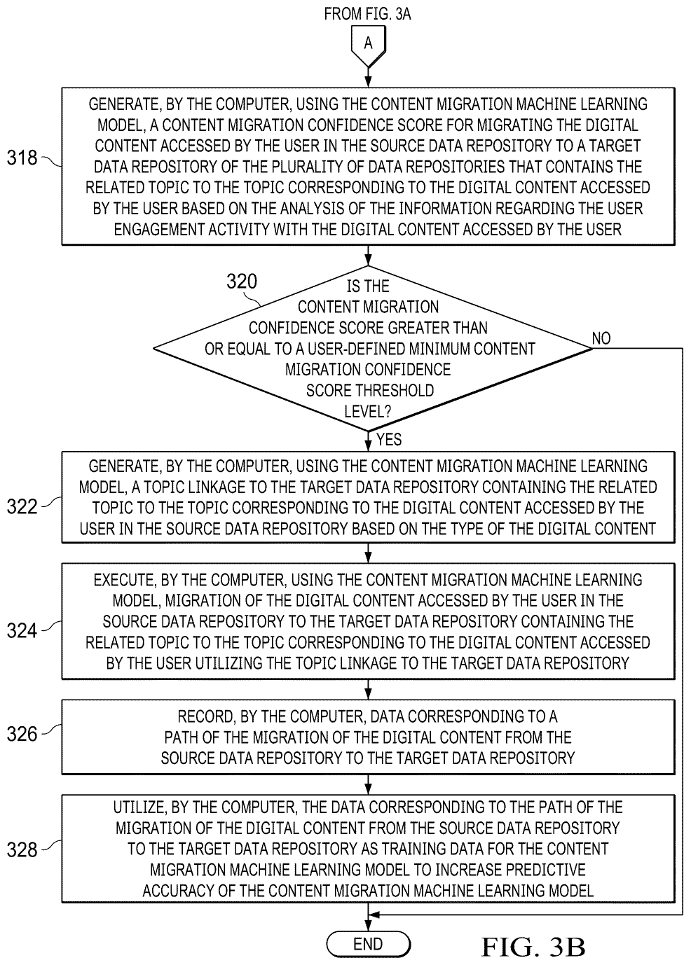

With reference now to FIGS. 3A-3B, a flowchart illustrating a process for migrating digital content is shown in accordance with an illustrative embodiment. The process shown in FIGS. 3A-3B may be implemented in a computer, such as, for example, computer 101 in FIG. 1 or computer 202 in FIG. 2. For example, the process shown in FIGS. 3A-3B may be implemented in content migration management code 200 in FIG. 1 or content migration machine learning model 201 in FIG. 2.

The process begins when the computer receives an indication that a user is accessing digital content in a source data repository via a network using a client device (step 302). The source data repository is one of a plurality of data repositories storing different digital content related to different topics. In addition, each of the plurality of data repositories is ranked according to a content fluidity spectrum.

In response to the computer receiving the indication, the computer performs a topic analysis of the digital content accessed by the user in the source data repository (step 304). The computer identifies a topic corresponding to the digital content accessed by the user in the source data repository based on the topic analysis (step 306). Further, the computer identifies where a related topic to the topic corresponding to the digital content accessed by the user in the source data repository is located in the plurality of data repositories based on a type of the digital content (step 308).

Also, the computer retrieves collected reference data and collected transaction data corresponding to the digital content accessed by the user in the source data repository (step 310). The computer performs an analysis of the collected reference data and the collected transaction data corresponding to the digital content accessed by the user in the source data repository (step 312). The computer generates information regarding user engagement activity with the digital content accessed by the user in the source data repository based on the analysis of the collected reference data and the collected transaction data corresponding to the digital content (step 314).

The computer, using a content migration machine learning model, performs an analysis of the information regarding the user engagement activity with the digital content accessed by the user in the source data repository (step 316). The computer, using the content migration machine learning model, generates a content migration confidence score for migrating the digital content accessed by the user in the source data repository to a target data repository of the plurality of data repositories that contains the related topic to the topic corresponding to the digital content accessed by the user based on the analysis of the information regarding the user engagement activity with the digital content accessed by the user (step 318).

The computer makes a determination as to whether the content migration confidence score is greater than or equal to a user-defined minimum content migration confidence score threshold level (step 320). If computer determines that the content migration confidence score is not greater than or equal to (i.e., is less than) the user-defined minimum content migration confidence score threshold level, no output of step 320, then the process terminates thereafter (i.e., the computer does not migrate the digital content from the source data repository). If computer determines that the content migration confidence score is greater than or equal to the user-defined minimum content migration confidence score threshold level, yes output of step 320, then the computer, using the content migration machine learning model, generates a topic linkage to the target data repository containing the related topic to the topic corresponding to the digital content accessed by the user in the source data repository based on the type of the digital content (step 322).

Afterward, the computer, using the content migration machine learning model, executes migration of the digital content accessed by the user in the source data repository to the target data repository containing the related topic to the topic corresponding to the digital content accessed by the user utilizing the topic linkage to the target data repository (step 324). The computer records data corresponding to a path of the migration of the digital content from the source data repository to the target data repository (step 326). The data corresponding to the path of the migration of the digital content include a unique identifier for the digital content that preserves the topic linkage between the source data repository and the target data repository. The computer utilizes the data corresponding to the path of the migration of the digital content from the source data repository to the target data repository as training data for the content migration machine learning model to increase predictive accuracy of the content migration machine learning model (step 328). Thereafter, the process terminates.

Thus, illustrative embodiments of the present invention provide a computer-implemented method, computer system, and computer program product for automatically migrating digital content across a plurality of data repositories according to a content fluidity spectrum using a trained content migration machine learning model. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for migrating digital content, the computer-implemented method comprising:
generating, by a computer, using a content migration machine learning model, a content migration confidence score for migrating digital content accessed by a user in a source data repository to a target data repository of a plurality of data repositories that contains a related topic to a topic corresponding to the digital content accessed by the user based on an analysis of information regarding user engagement activity with the digital content accessed by the user; and
executing, by the computer, using the content migration machine learning model, migration of the digital content accessed by the user in the source data repository to the target data repository containing the related topic to the topic corresponding to the digital content accessed by the user in response to the computer determining that the content migration confidence score is greater than a user-defined minimum content migration confidence score threshold level.

2. The computer-implemented method of claim 1, further comprising:
generating, by the computer, using the content migration machine learning model, a topic linkage to the target data repository containing the related topic to the topic corresponding to the digital content accessed by the user in the source data repository based on a type of the digital content; and
executing, by the computer, using the content migration machine learning model, the migration of the digital content accessed by the user in the source data repository to the target data repository containing the related topic to the topic corresponding to the digital content accessed by the user utilizing the topic linkage to the target data repository.

3. The computer-implemented method of claim 2, further comprising:
recording, by the computer, data corresponding to a path of the migration of the digital content from the source data repository to the target data repository, wherein the data corresponding to the path of the migration of the digital content include a unique identifier for the digital content that preserves the topic linkage between the source data repository and the target data repository; and
utilizing, by the computer, the data corresponding to the path of the migration of the digital content from the source data repository to the target data repository as training data for the content migration machine learning model to increase predictive accuracy of the content migration machine learning model.

4. The computer-implemented method of claim 1, further comprising:
receiving, by the computer, an indication that the user is accessing the digital content in the source data repository via a network using a client device, wherein the source data repository is one of the plurality of data repositories storing different digital content related to different topics;
performing, by the computer, a topic analysis of the digital content accessed by the user in the source data repository; and
identifying, by the computer, the topic corresponding to the digital content accessed by the user in the source data repository based on the topic analysis.

5. The computer-implemented method of claim 1, further comprising:
identifying, by the computer, where the related topic to the topic corresponding to the digital content accessed by the user in the source data repository is located in the plurality of data repositories based on a type of the digital content.

6. The computer-implemented method of claim 1, further comprising:
retrieving, by the computer, reference data and transaction data corresponding to the digital content accessed by the user in the source data repository; and
performing, by the computer, an analysis of the reference data and the transaction data corresponding to the digital content accessed by the user in the source data repository.

7. The computer-implemented method of claim 1, further comprising:
generating, by the computer, the information regarding the user engagement activity with the digital content accessed by the user in the source data repository based on an analysis of reference data and transaction data corresponding to the digital content; and
performing, by the computer, using the content migration machine learning model, the analysis of the information regarding the user engagement activity with the digital content accessed by the user in the source data repository.

8. A computer system for migrating digital content, the computer system comprising:
a communication fabric;
a storage device connected to the communication fabric, wherein the storage device stores program instructions; and
a processor connected to the communication fabric, wherein the processor executes the program instructions to:
generate, using a content migration machine learning model, a content migration confidence score for migrating digital content accessed by a user in a source data repository to a target data repository of a plurality of data repositories that contains a related topic to a topic corresponding to the digital content accessed by the user based on an analysis of information regarding user engagement activity with the digital content accessed by the user; and
execute, using the content migration machine learning model, migration of the digital content accessed by the user in the source data repository to the target data repository containing the related topic to the topic corresponding to the digital content accessed by the user in response to determining that the content migration confidence score is greater than a user-defined minimum content migration confidence score threshold level.

9. The computer system of claim 8, wherein the processor further executes the program instructions to:
generate, using the content migration machine learning model, a topic linkage to the target data repository containing the related topic to the topic corresponding to the digital content accessed by the user in the source data repository based on a type of the digital content; and
execute, using the content migration machine learning model, the migration of the digital content accessed by the user in the source data repository to the target data repository containing the related topic to the topic corresponding to the digital content accessed by the user utilizing the topic linkage to the target data repository.

10. The computer system of claim 9, wherein the processor further executes the program instructions to:
record data corresponding to a path of the migration of the digital content from the source data repository to the target data repository, wherein the data corresponding to the path of the migration of the digital content include a unique identifier for the digital content that preserves the topic linkage between the source data repository and the target data repository; and
utilize the data corresponding to the path of the migration of the digital content from the source data repository to the target data repository as training data for the content migration machine learning model to increase predictive accuracy of the content migration machine learning model.

11. The computer system of claim 8, wherein the processor further executes the program instructions to:
receive an indication that the user is accessing the digital content in the source data repository via a network using a client device, wherein the source data repository is one of the plurality of data repositories storing different digital content related to different topics;
perform a topic analysis of the digital content accessed by the user in the source data repository; and
identify the topic corresponding to the digital content accessed by the user in the source data repository based on the topic analysis.

12. The computer system of claim 8, wherein the processor further executes the program instructions to:
identify where the related topic to the topic corresponding to the digital content accessed by the user in the source data repository is located in the plurality of data repositories based on a type of the digital content.

13. The computer system of claim 8, wherein the processor further executes the program instructions to:
retrieve reference data and transaction data corresponding to the digital content accessed by the user in the source data repository; and
perform an analysis of the reference data and the transaction data corresponding to the digital content accessed by the user in the source data repository.

14. A computer program product for migrating digital content, the computer program product comprising a computer-readable storage medium having program instructions embodied therewith, the program instructions executable by a computer to cause the computer to perform a method of:
generating, by the computer, using a content migration machine learning model, a content migration confidence score for migrating digital content accessed by a user in a source data repository to a target data repository of a plurality of data repositories that contains a related topic to a topic corresponding to the digital content accessed by the user based on an analysis of information regarding user engagement activity with the digital content accessed by the user; and
executing, by the computer, using the content migration machine learning model, migration of the digital content accessed by the user in the source data repository to the target data repository containing the related topic to the topic corresponding to the digital content accessed by the user in response to the computer determining that the content migration confidence score is greater than a user-defined minimum content migration confidence score threshold level.

15. The computer program product of claim 14, further comprising:
generating, by the computer, using the content migration machine learning model, a topic linkage to the target data repository containing the related topic to the topic corresponding to the digital content accessed by the user in the source data repository based on a type of the digital content; and
executing, by the computer, using the content migration machine learning model, the migration of the digital content accessed by the user in the source data repository to the target data repository containing the related topic to the topic corresponding to the digital content accessed by the user utilizing the topic linkage to the target data repository.

16. The computer program product of claim 15, further comprising:
recording, by the computer, data corresponding to a path of the migration of the digital content from the source data repository to the target data repository, wherein the data corresponding to the path of the migration of the digital content include a unique identifier for the digital content that preserves the topic linkage between the source data repository and the target data repository; and
utilizing, by the computer, the data corresponding to the path of the migration of the digital content from the source data repository to the target data repository as training data for the content migration machine learning model to increase predictive accuracy of the content migration machine learning model.

17. The computer program product of claim 14, further comprising:
receiving, by the computer, an indication that the user is accessing the digital content in the source data repository via a network using a client device, wherein the source data repository is one of the plurality of data repositories storing different digital content related to different topics;
performing, by the computer, a topic analysis of the digital content accessed by the user in the source data repository; and
identifying, by the computer, the topic corresponding to the digital content accessed by the user in the source data repository based on the topic analysis.

18. The computer program product of claim 14, further comprising:
identifying, by the computer, where the related topic to the topic corresponding to the digital content accessed by the user in the source data repository is located in the plurality of data repositories based on a type of the digital content.

19. The computer program product of claim 14, further comprising:
retrieving, by the computer, reference data and transaction data corresponding to the digital content accessed by the user in the source data repository; and
performing, by the computer, an analysis of the reference data and the transaction data corresponding to the digital content accessed by the user in the source data repository.

20. The computer program product of claim 14, further comprising:
generating, by the computer, the information regarding the user engagement activity with the digital content accessed by the user in the source data repository based on an analysis of reference data and transaction data corresponding to the digital content; and
performing, by the computer, using the content migration machine learning model, the analysis of the information regarding the user engagement activity with the digital content accessed by the user in the source data repository.
